(19) United States
(12) Patent Application Publication
(10) Pub. No.: US 2020/0226708 A1
(43) Pub. Date: Jul. 16, 2020

(54) SYSTEMS AND METHODS FOR IDENTIFYING INCORRECT ORDER REQUEST

(71) Applicant: BEIJING DIDI INFINITY TECHNOLOGY AND DEVELOPMENT CO., LTD., Beijing (CN)

(72) Inventors: Licai QI, Hangzhou (CN); Hengzhi WANG, Hangzhou (CN); Yifei ZHANG, Hangzhou (CN)

(73) Assignee: BEIJING DIDI INFINITY TECHNOLOGY AND DEVELOPMENT CO., LTD., Beijing (CN)

(21) Appl. No.: 16/831,945

(22) Filed: Mar. 27, 2020

Related U.S. Application Data
(63) Continuation of application No. PCT/CN2018/109039, filed on Sep. 30, 2018.

(30) Foreign Application Priority Data
Sep. 30, 2017 (CN) 201710938481.4

(51) Int. Cl. G06Q 50/30; H04W 4/20; H04M 1/725

(52) U.S. Cl. CPC G06Q 50/30; H04M 1/72566; H04W 4/20

(57) ABSTRACT

A method for identifying an incorrect order request is provided. The method may include receiving an order request from a user terminal of a passenger. The method may include determining a probability of incorrection for the order request by analyzing values of a plurality of features from the order request with a target identification model. The method may include identifying the order request as an incorrect order request or a correct order request based on the probability of incorrection of the order request. The method may further include communicating with the passenger through the user terminal in response to an identification that the order request is an incorrect order request.

### CROSS-REFERENCE TO RELATED APPLICATIONS

This application is a continuation of International Application No. PCT/CN2018/109039, filed on Sep. 30, 2018, which claims priority of Chinese Patent Application No. 201710938481.4, filed on Sep. 30, 2017, the entire contents of which are hereby incorporated by reference.

### TECHNICAL FIELD

The present disclosure generally relates to computer technology, and more particularly, relates to systems and methods for identifying incorrect order request based on an identification model.

### BACKGROUND

Online to offline services (e.g., car-hailing services) have become more and more popular. Through an online service platform, a user can request an online to offline service by an application installed in his/her mobile device (e.g., a smart phone). In some occasions, the user may input an incorrect order request that goes against his/her real intention. For example, while a user actually wants to request an Express car service, he/she may inadvertently input a request for a designated driving service by mistake. If the user is aware of the incorrect order request, the user can usually cancel the order request. However, the cancellation of the order request may result in a poor experience for a service provider (e.g., a driver), and in some cases, even causing loss of registered service providers in the online service platform. Therefore, it is desirable to develop systems and methods for identifying a potential incorrect order request in order to improve efficiency and/or reduce waste.

### SUMMARY

According to an aspect of the present disclosure, a system for identifying an incorrect order request in an online to offline service is provided. The system may include a computer-readable storage medium storing executable instructions for identifying the incorrect order request, and at least one processor in communication with the computer-readable storage medium. When executing the executable instructions, the at least one processor may receive an order request from a user terminal of a passenger. The order request may include values of a plurality of features. The at least one processor may determine a probability of incorrection for the order request by analyzing the values of the plurality of features from the order request with a target identification model. The target identification model may be obtained by training an identification model with a plurality of historical orders. The at least one processor may identify the order request as an incorrect order request or a correct order request based on the probability of incorrection of the order request. The at least one processor may further communicate with the passenger through the user terminal in response to an identification that the order request is an incorrect order request.

In some embodiments, in response to the identification that the order request is an incorrect order request, the at least one processor may interrupt an order allocation of the order request.

In some embodiments, the at least one processor may delay the order allocation of the order request for a predetermined time period.

In some embodiments, the at least one processor may transmit a first reminder signal to the user terminal. The first reminder signal may direct the user terminal of the passenger to display a reminder message that the order request is an incorrect order.

In some embodiments, the first reminder signal may direct the user terminal of the passenger to generate a reminder sound by a speaker of the user terminal to notify the passenger that the order request is an incorrect order.

In some embodiments, the first reminder signal may direct the user terminal of the passenger to display a recommended order request to replace the order request.

In some embodiments, the first reminder signal may direct the user terminal of the passenger to display inquiry, which prompts the passenger to confirm or deny the identification that the order request is an incorrect request.

In some embodiments, the at least one processor may transmit a second reminder signal to a user terminal of a driver. When the order request is allocated to the driver, the second reminder signal may direct the user terminal of the driver to display a reminder to the driver that the order request is likely an incorrect order request.

In some embodiments, for each of the plurality of historical orders, the at least one processor may label the historical order based on whether the historical order is an incorrect order and extract at least one feature of the historical order. The at least one processor may apply the plurality of labelled historical orders and the plurality of at least one type of features into the identification model. The at least one processor may adjust parameters of the identification model to minimize an objective function including a loss function of the identification model.

In some embodiments, the target identification model may include an Extreme Gradient Boosting (Xgboost) model.

According to another aspect of the present disclosure, a method is provided. The method may include one or more of the following operations. At least one processor may an order request from a user terminal of a passenger. The order request may include values of a plurality of features. The at least one processor may determine a probability of incorrection for the order request by analyzing the values of the plurality of features from the order request with a target identification model. The target identification model may be obtained by training an identification model with a plurality of historical orders. The at least one processor may identify the order request as an incorrect order request or a correct order request based on the probability of incorrection of the order request. The at least one processor may further communicate with the passenger through the user terminal in response to an identification that the order request is an incorrect order request.

According to another aspect of the present disclosure, a non-transitory computer readable medium is provided. The non-transitory computer readable medium may comprise executable instructions that cause at least one processor to effectuate a method. The method may include one or more of the following operations. The at least one processor may an order request from a user terminal of a passenger. The order request may include values of a plurality of features. The at least one processor may determine a probability of incorrection for the order request by analyzing the values of the plurality of features from the order request with a target identification model. The target identification model may be obtained by training an identification model with a plurality of historical orders. The at least one processor may identify the order request as an incorrect order request or a correct order request based on the probability of incorrection of the order request. The at least one processor may further communicate with the passenger through the user terminal in response to an identification that the order request is an incorrect order request.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary incorrect order request identification (IORI) system according to some embodiments of the present disclosure;

FIG. 2 is a schematic diagram illustrating exemplary components of a computing device according to some embodiments of the present disclosure;

FIG. 3 is a schematic diagram illustrating exemplary hardware and/or software components of an exemplary mobile terminal according to some embodiments of the present disclosure;

FIG. 4 is a block diagram illustrating an exemplary processing device according to some embodiments of the present disclosure;

FIG. 5 is a flowchart illustrating an exemplary process for identifying an incorrect order request according to some embodiments of the present disclosure;

FIG. 6 is a flowchart illustrating an exemplary process for training an identification model according to some embodiments of the present disclosure;

FIG. 7 is a flowchart illustrating an exemplary process for determining a target identification model according to some embodiments of the present disclosure; and

FIG. 8 is a schematic diagram illustrating an exemplary structure of a model tree according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure. However, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flowcharts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure are described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

In an aspect, the present disclosure is directed to systems and methods for identifying an incorrect order request. The system may receive an order request from a user, and determine a probability of incorrection of the current order request by using an identification model. The system may identify whether the current order request is an incorrect order request based on the probability of incorrection. If the system identifies the current order request as an incorrect order request, the system may interrupt an order allocation of the current order request. In some embodiments, the system may communicate with the user for reminding the user to check his/her order request. The user may modify the order request if the user determines that the order request is incorrect. The system may reduce order cancellation caused by incorrect order request, and also improve the service experience for a service provider (e.g., a car-hailing driver).

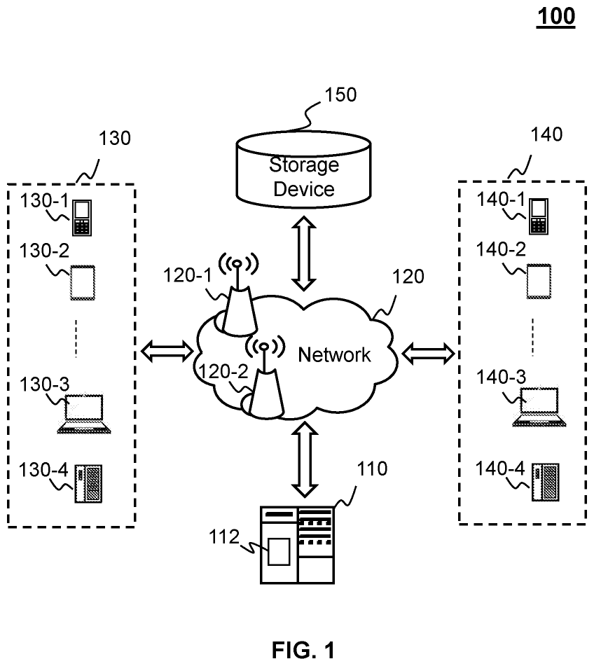

FIG. 1 is a schematic diagram illustrating an exemplary incorrect order request identification (IORI) system according to some embodiments of the present disclosure. For example, the IORI system 100 may be an online to offline service platform for processing a service order request from a user (e.g., a car-hailing service request). In some embodiments, the service may be a transportation service, such as a taxi hailing service, a chauffeur service, a delivery vehicle service, a carpool service, a bus service, a driver hiring service and a shuttle service. In some embodiment, the service may be any online service, such as booking a meal, shopping, or the like, or any combination thereof. The system 100 may be a platform including a server 110, a network 120, a requestor terminal 130, a provider terminal 140, and a storage device 150.

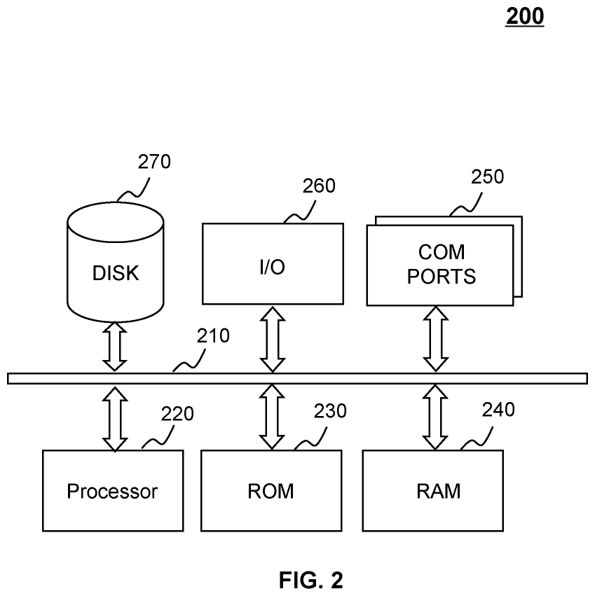

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the storage device 150 via the network 120. As another example, the server 110 may be directly connected to the requestor terminal 130, the provider terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. The processing device 112 may process information and/or data relating to an order request to perform one or more functions described in the present disclosure. For example, the processing device 112 may receive an order request and identify the order request whether is an incorrect order request based on a target identification model (e.g., an Xgboost model). The processing device 112 may train an identification model with a plurality of historical orders to determine the target identification model. In some embodiments, the processing device 112 may include one or more processing devices (e.g., single-core processing device(s) or multi-core processor(s)). Merely by way of example, the processing device 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the system 100 (e.g., the server 110, the requestor terminal 130, the provider terminal 140, and/or the storage device 150) may send information and/or data to other component(s) in the system 100 via the network 120. For example, the server 110 may obtain/acquire order request (e.g., a car-hailing service request) from the requestor terminal 130 via the network 120. As another example, the server 110 may communicate with the requestor terminal 130 and/or the provider terminal 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the IORI system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may use the provider terminal 140 to receive an order request for a user D, and/or information or instructions from the server 110. In some embodiments, “requestor” and “requestor terminal” may be used interchangeably, “user” and “user terminal” may be used interchangeably, and “provider” and “provider terminal” may be used interchangeably. For an on-demand transportation service, a requestor may be a passenger, a provider may be a driver.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, a built-in device in the motor vehicle 130-4 may include an onboard computer, an onboard television, etc. In some embodiments, the requestor terminal 130 may be a device with positioning technology (e.g., GPS) for locating the position of the requestor and/or the requestor terminal 130.

In some embodiments, the provider terminal 140 may be a device that is similar to, or the same as the requestor terminal 130. In some embodiments, the provider terminal 140 may be a device utilizing positioning technology for locating the position of a user of the provider terminal 140 (e.g., a service provider) and/or the provider terminal 140. In some embodiments, the requestor terminal 130 and/or the provider terminal 140 may communicate with one or more other positioning devices to determine the position of the requestor, the requestor terminal 130, the provider, and/or the provider terminal 140. In some embodiments, the requestor terminal 130 and/or the provider terminal 140 may send positioning information to the server 110. In some embodiments, the requestor terminal 130 and/or the provider terminal 140 may display information related with an order request (e.g., a pick-up location, a drop-off location, a route).

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

The storage device 150 may store data and/or instructions. In some embodiments, the storage device 150 may store data obtained from the requestor terminal 130 and/or the provider terminal 140. In some embodiments, the storage device 150 may store data and/or instructions that the server 110 may execute or use to perform exemplary methods described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the IORI system 100 (e.g., the server 110, the requestor terminal 130, the provider terminal 140, etc.). One or more components in the IORI system 100 may access the data or instructions stored in the storage device 150 via the network 120. In some embodiments, the storage device 150 may be directly connected to or communicate with one or more components in the IORI system 100 (e.g., the server 110, the requestor terminal 130, the provider terminal 140, etc.). In some embodiments, the storage device 150 may be part of the server 110.

In some embodiments, one or more components in the IORI system 100 (e.g., the server 110, the requestor terminal 130, the provider terminal 140, etc.) may have permission to access the storage device 150. In some embodiments, one or more components in the IORI system 100 may read and/or modify information relating to the requestor, provider, and/or the public when one or more conditions are met. For example, the server 110 may read and/or modify one or more users' information after a service is completed. As another example, the provider terminal 140 may access information relating to the requestor when receiving an order request from the requestor terminal 130, but the provider terminal 140 may not modify the relevant information of the requestor.

In some embodiments, information exchanging of one or more components in the IORI system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the IORI system 100 performs, the element may perform through electrical signals and/or electromagnetic signals. For example, when a requestor terminal 130 processes a task, such as making a determination, identifying or selecting an object, the requestor terminal 130 may operate logic circuits in its processor to process such task. When the requestor terminal 130 sends out an order request to the server 110, a processor of the requestor terminal 130 may generate electrical signals encoding the service request. The processor of the requestor terminal 130 may then send the electrical signals to an output port. If the requestor terminal 130 communicates with the server 110 via a wired network, the output port may be physically connected to a cable, which may further transmit the electrical signals to an input port of the server 110. If the requestor terminal 130 communicates with the server 110 via a wireless network, the output port of the requestor terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requestor terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary components of a computing device according to some embodiments of the present disclosure. The server 110, the requestor terminal 130, the provider terminal 140, and/or the storage device 150 may be implemented on the computing device 200 according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the system 100 as described herein. In FIGS. 1 and 2, only one such computer device is shown purely for convenience purposes. One of ordinary skill in the art would understand at the time of filing of this application that the computer functions relating to the service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read-only memory (ROM) 230, or a random access memory (RAM) 240, for various data files to be processed and/or transmitted by the computing device. The exemplary computing device may also include program instructions stored in the ROM 230, RAM 240, and/or another type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both operation A and operation B, it should be understood that operation A and operation B may also be performed by two different CPUs and/or processors jointly or separately in the computing device 200 (e.g., the first processor executes operation A and the second processor executes operation B, or the first and second processors jointly execute operations A and B).

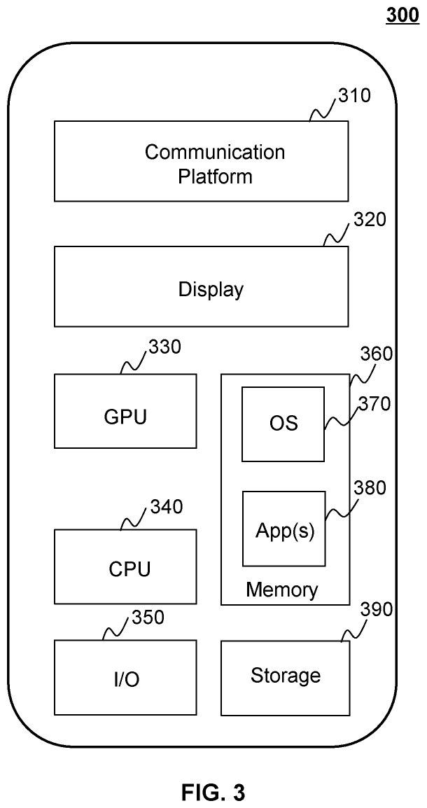

FIG. 3 is a schematic diagram illustrating exemplary hardware and/or software components of an exemplary mobile device according to some embodiments of the present disclosure. The requestor terminal 130 may be implemented on the mobile device 300 according to some embodiments of the present disclosure. As illustrated in FIG. 3, the mobile device 300 may include a communication module 310, a display 320, a graphics processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™ Windows Phone™) and one or more applications 380 may be loaded into the memory 360 from the storage 390 in order to be executed by the CPU 340. The applications 380 may include a browser or any other suitable mobile apps for transmitting the trajectory data to the server 110. User interaction with the information stream may be achieved via the I/O devices 350 and provided to the processing device 112 and/or other components of the system 100 via the network 120.

In order to implement various modules, units and their functions described above, a computer hardware platform may be used as hardware platforms of one or more elements (e.g., a component of the server 110 described in FIG. 1). Since these hardware elements, operating systems, and program languages are common, it may be assumed that persons skilled in the art may be familiar with these techniques and they may be able to provide information required in the traffic lights controlling according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

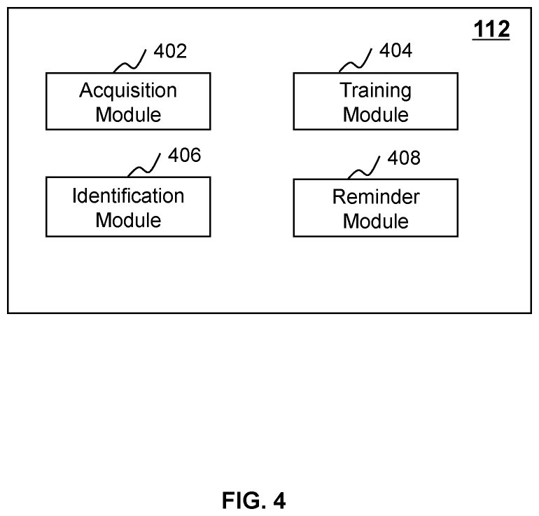

FIG. 4 is a block diagram illustrating an exemplary processing device according to some embodiments of the present disclosure. In some embodiments, the processing device 112 may include an acquisition module 402, a training module 404, an identification module 406, and a remind module 408.

The modules may be hardware circuits of at least part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application/set of instructions.

The acquisition module 402 may obtain an order request from a user terminal of a passenger. In some embodiments, the acquisition module 402 may further obtain values of a plurality of features associated with the order request in response to the order request. In some embodiments, the plurality of features of the order request may include a travel mode (e.g., an Express car mode, an ExpressPool car mode, a luxury car mode, a business van mode, etc.), a pick-up location, a drop-off location, a current time (e.g., rush hours or non-rush hours), a price, a tip, the number of order requests a region or neighborhood, the number of candidate drivers in a region or neighborhood, a weather condition, a traffic condition, a passenger age, a passenger gender, a passenger job, an order cancellation rate, or the like, or any combination thereof.

In some embodiments, the acquisition module 402 may label a plurality of historical orders based on whether the historical order is an incorrect order. For example, the acquisition module 402 may obtain the plurality of historical orders from a storage (e.g., the storage device 150). The acquisition module 402 may label a correct historical order and/or an incorrect historical order with a binary value respectively. For example, a correct historical order may be labelled by “1”, an incorrect historical order may be labelled by “0”.

In some embodiments, the acquisition module 402 may extract at least one feature of each of the plurality of labelled historical orders. Exemplary feature may include basic features, real-time features or passenger features, or the like, or any combination thereof. The basic feature may include a travel mode (e.g., an Express car mode, an ExpressPool car mode, a luxury car mode, a business van mode, etc.), a pick-up location, a drop-off location, a price, a tip, or the like, or any combination thereof. The real-time feature may include a weather condition, a time, a traffic condition, the number of order requests in a region or neighborhood, the number of candidate drivers in a region or neighborhood, or the like, or any combination thereof. The passenger feature may include a passenger age, a passenger gender, a passenger job, an order cancellation rate, or the like, or any combination thereof.

In some embodiments, the acquisition module 402 may classify a plurality of labelled historical orders into a training set and a testing set. The testing set may include a first portion of labelled historical orders (herein also referred to as training samples). The testing set may include a second portion of labelled historical orders (herein also referred to as testing samples). The training set may be used to train the identification module, and the testing set may be used to verify an accuracy of the trained identification model.

The training module 404 may train an identification model for identifying whether an order request is an incorrect order request. The identification model may include an Extreme Gradient Boosting (Xgboost) model, a decision tree model, a Gradient Boosted Decision Tree (GBDT) model, a linear regression model, a neural network model, or the like, or any combination thereof. In preferred embodiments, the identification model may be the Xgboost model. The Xgboost model may include one or more model trees. The identification model may output a probability of incorrection of an order request.

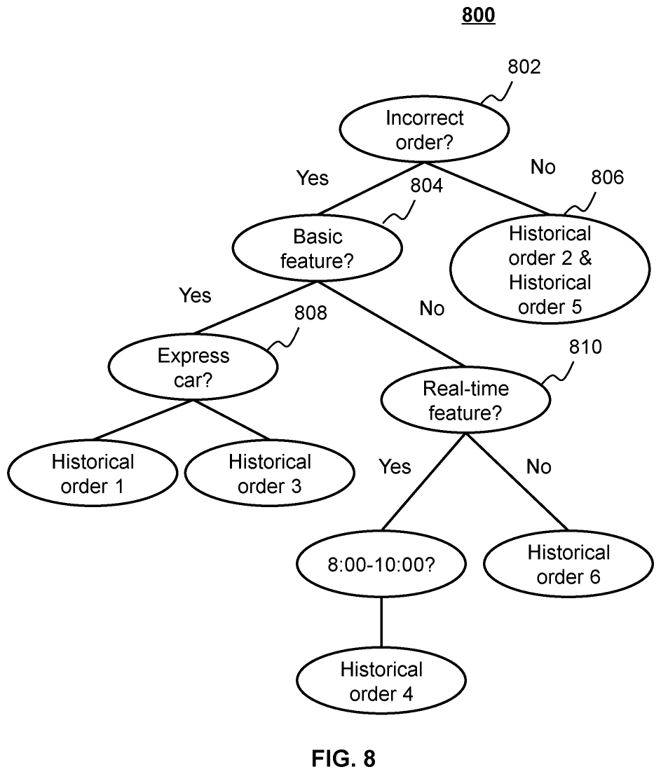

In some embodiments, the training module 404 may apply the plurality of historical orders and the plurality of extracted features into the identification model. The training module 404 may adjust parameters of the identification model to minimize an objective function of the identification model. In some embodiments, the objective function of the identification model may include a loss function (e.g., L(θ)) and a regularization factor (e.g., Ω(θ). For the Xgboost model, the training module 404 may determine one or more model trees (e.g., the model tree 800 as illustrated in FIG. 8). The training module 404 may spilt each model tree into a plurality of leaves based on the features. Each spilt point may correspond to a feature. The one or more model trees may construct the identification model.

In some embodiments, the training module 404 may determine a target identification model. The training module 404 may validate the trained identification model based on the testing set, and determine a target identification model based on a result of the validation. The result of the validation may include an accuracy of the identification model. The accuracy of the identification model may refer to a ratio between the number of identified incorrect orders and the number of actual incorrect orders including in the testing samples. In some embodiments, if the accuracy of identification model is equal to or greater than a predetermined accuracy threshold (e.g., 0.6, 0.65, 0.7, 0.75, 0.85, 0.90, or 0.95), the processor may designate the identification model as the target identification model.

The identification module 406 may identify the order request as an incorrect order request or a correct order request based on the probability of incorrection of an order request. The target identification model may determine the probability of incorrection of an order request. If the probability of incorrection of the order request is equal to or greater than a predetermined threshold (e.g., 0.6, 0.65, 0.7, 0.75, 0.85, 0.90, or 0.95), the processor may identify the order request as an incorrect order request.

The reminder module 408 may communicate with the passenger through the user terminal in response to an identification that the order request is an incorrect request. In some embodiments, the reminder module 408 may interrupt an order allocation of the order request in response to the identification that the order request is an incorrect order request. For example, the reminder module 408 may delay the order allocation of the order request for a predetermined time period (e.g., 5 seconds, 10 seconds, 20 seconds, 30 seconds, 60 seconds, 2 minutes, 3 minutes, or 5 minutes).

In some embodiments, the reminder module 408 may generate a first reminder signal and transmit the first reminder signal to the user terminal of the passenger (e.g., the requestor terminal 130) when the order request is identified as the incorrect order request. In some embodiments, the first reminder signal may direct the user terminal of the passenger to display a reminder message indicating that the order request may be an incorrect order request. In some embodiments, the first reminder signal may direct the user terminal of the passenger to generate a reminder sound by a speaker of the user terminal to notify the passenger that the order request is an incorrect order request. In some embodiments, the first reminder signal may direct the user terminal of the passenger to display a recommend order request indicating a potential correct order request for replacing the order request. In some embodiments, the first reminder signal may direct the user terminal of the passenger to display an inquiry option that prompts the passenger to confirm or deny the identification that the order request is an incorrect request.

In some embodiments, the reminder module 408 may generate a second reminder signal and transmit the second reminder signal to a user terminal of the driver (e.g., the provider terminal 140) when the order request is identified as the incorrect order request. The second reminder signal may direct the user terminal of the driver to display a reminder, indicating the order request is likely an incorrect order request, to the driver.

It should be noted that the above description of the processing device 112 is merely provided for the purposes of illustration, and not intended to limit the scope of the present disclosure. For persons having ordinary skills in the art, multiple variations and modifications may be made under the teachings of the present disclosure. For example, the processing device 112 may further include a storage module to facilitate data storage. However, those variations and modifications do not depart from the scope of the present disclosure.

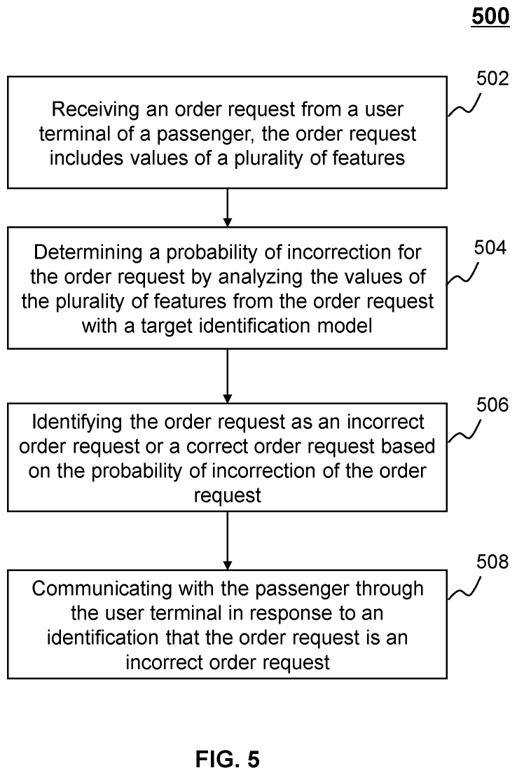

FIG. 5 is a flowchart illustrating an exemplary process for identifying an incorrect order request according to some embodiments of the present disclosure. In some embodiments, the process 500 may be implemented in the IORI system 100. For example, the process 500 may be stored in the storage device 150 and/or the storage (e.g., the ROM 230, the RAM 240, or the storage 390) as the form of instructions, and invoked and/or executed by the server 110 (e.g., the processing device 112 of the server 110, or the processor 220 of the computing device 200).

In 502, the processor (e.g., the acquisition module 402 of the processing device 112) may receive an order request from a user terminal of a passenger, and the order request includes values of a plurality of features. For example, the passenger sends out an order request for a car-hailing service by the requestor terminal 130, the acquisition module 402 may receive the order request and extract the values of the plurality of features associated with the order request in response to the order request. In some embodiments, the acquisition module 402 may transmit the values of the plurality of features to the identification module 406 for analyzing whether the received order request is an incorrect order request. In some embodiments, the application (e.g., car-hailing application) installed in the passenger's mobile device is configured to detect user input. In certain embodiments, the order request may be in the form of a partially-entered request that is not sent or a complete request that is not sent. In certain embodiments, such kind of yet-to-be-sent order requests may also trigger the process as shown in the present disclosure (e.g., process 500 shown in FIG. 5).

In some embodiments, the plurality of features of the current order request may include a travel mode (e.g., an Express car mode, an ExpressPool car mode, a luxury car mode, a business van mode, etc.), a pick-up location, a drop-off location, a current time (e.g., rush hours or non-rush hours), a price, a tip, the number of order requests in a region or neighborhood, the number of candidate drivers in a region or neighborhood, a weather condition, a traffic condition, a passenger age, a passenger gender, a passenger job, an order cancellation rate, or the like, or any combination thereof. It should be understood for those skilled in the art that the processor (e.g., the acquisition module 402) may extract values of the plurality of features of the order request once the processor receives the order request.

In 504, the processor (e.g., the identification module 406 of the processing device 112) may determine a probability of incorrection for the order request by analyzing the values of the plurality of features from the order request with a target identification model. In some embodiments, the target identification model may be an artificial intelligence (AI) model determined by a machine learning method. For example, the target identification model may include an Extreme Gradient Boosting (Xgboost) model, a decision tree model, a Gradient Boosted Decision Tree (GBDT) model, a linear regression model, a neural network model, and so on. In some embodiments, the target identification model may be determined by training a preliminary identification model with a plurality of historical orders. When an accuracy of the identification model is equal to or greater than a predetermined accuracy threshold (e.g., 0.6, 0.65, 0.7, 0.75, 0.85, 0.90, or 0.95), the identification model may be designated as the target identification model. Each of the plurality of historical orders for training the identification model may be a correct order or an incorrect order. The correct order may refer to an order that reflects the real intention of the passenger. The incorrect order may refer to an order that is inconsistent with the real intention of the passenger. In more cases, when the passenger finds out about the incorrect order, the passenger usually cancels the order request of the incorrect order. For example, passenger A sends out an order request for a trip from location P1 to location P2, while the passenger A actually intends to go to location P3. Passenger A may cancel the order request when he/she finds out that the order request is incorrect, and resend a new order request for a trip from location P1 to location P3. The canceled order may be the incorrect order. In some embodiments, the processor may label a historical order as a correct order or an incorrect order.

In some embodiments, each of the plurality of historical orders may include a plurality of features. The processor may extract the plurality of features for training the identification model. In some embodiments, the features may include basic features, real-time features, passenger features, or the like, or any combination thereof. The basic feature may include travel mode (e.g., an Express car mode, an ExpressPool mode, a luxury car mode, a business van mode, etc.), a pick-up location, a drop-off location, a price, a tip, or the like, or any combination thereof. The real-time feature may include a weather condition, a time, a traffic condition, the number of order requests in a region or neighborhood, the number of candidate drivers in a region or neighborhood, or the like, or any combination thereof. The passenger feature may include a passenger age, a passenger gender, a passenger job, an order cancellation rate, or the like, or any combination thereof.

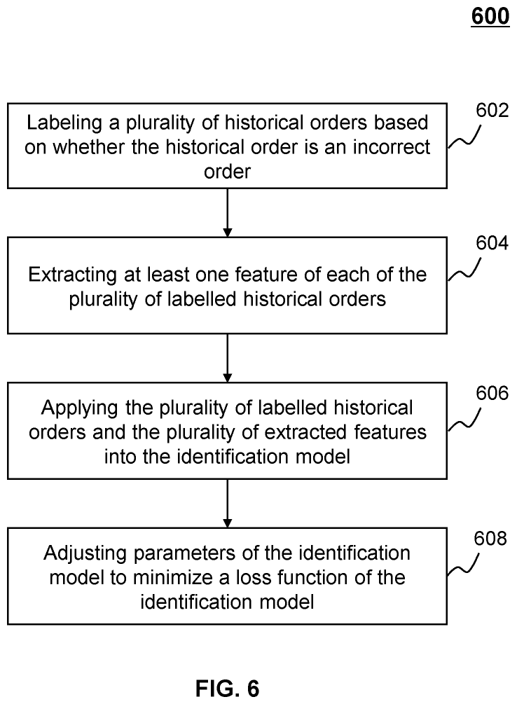

In some embodiments, the processor may invoke the target identification model to determine the probability of the current order request. More details about how to train the identification model may be found elsewhere in the present disclosure (e.g., FIGS. 6-8, and the descriptions thereof).

In 506, the processor (e.g., the identification module 406 of the processing device 112) may identify the order request as an incorrect order request or a correct order request based on the probability of incorrection of the order request. More specifically, if the probability of incorrection of the order request is equal to or greater than a predetermined threshold (e.g., 0.6, 0.65, 0.7, 0.75, 0.85, 0.90, or 0.95), the processor may identify the order request as an incorrect order request. Note that the order request may be identified as an incorrect order request based on a probabilistic result. In other words, when the probability of incorrection of the order request is equal to or greater than the predetermined threshold, the order request may be an incorrect order request with a high probability. The identified incorrect order request may be a potential incorrect order request, which means that it may not be an absolute incorrect order request.

Based on different scenarios and different goals, the threshold can be adjusted. In some embodiments, identifying an order request as incorrect carries the risk of doing so falsely and bothering the passenger with false alert. The passenger may be particularly annoyed if the passenger seldom makes any such mistakes. Therefore, in some embodiments, the predetermined threshold may be adjusted higher if there is a significant risk of reducing user experience with a false alarm. In some embodiments, the predetermined threshold may be adjusted lower if there is no such significant risk. For example, there may be three level of the predetermined threshold. In certain embodiments, the predetermined threshold may be adjusted to the highest level if the user seldom (e.g. less than 10% or 5% cancellation rate) makes incorrect order requests. In certain embodiments, the predetermined threshold may be adjusted to the lowest if the user regularly (e.g. more than 25% or 30% cancellation rate) makes incorrect order requests. In certain embodiments, the predetermined threshold may be kept as a middle level when the user does not have enough order history to make a sensible distinction or when the user's record indicates a middle level (not seldom, not regular) of making incorrect orders.

In 508, the processor (e.g., the reminder module 408 of the processing device 112) may communicate with the passenger through the user terminal in response to an identification that the order request is an incorrect request. In some embodiments, the processor may interrupt an order allocation of the order request in response to the identification that the order request is an incorrect order request. For example, the reminder module 408 may delay the order allocation of the order request for a predetermined time period (e.g., 5 seconds, 10 seconds, 20 seconds, 30 seconds, 60 seconds, 2 minutes, 3 minutes, or 5 minutes). The delayed time period may be adjusted by on the actions taken by the processor and/or communication between the processor and the user terminal. Generally, when there is no incorrect order identification process, once the processor receives an order request, the processor may allocate the order request for one or more candidate service providers (e.g., the drivers) in real time or close to real time. However, in this case, If the identification of the received order request is identified as an incorrect order request, the processor may delay the order allocation for the predetermined time period, in order to set aside a certain response time to check the order request for the passenger. By interrupting the order allocation of the order request, the processor may prevent a potential cancellation, which can be a waste of resources and reduction or work experience for the driver.

In some embodiments, the processor may generate a first reminder signal and transmit the first reminder signal to the user terminal of the passenger (e.g., the requestor terminal 130) when the order request is identified as the incorrect order request. In some embodiments, the first reminder signal may direct the user terminal of the passenger to display a reminder message indicating that the order request may be an incorrect order request. For example, the reminder module 408 of the processing device 112 may direct the user terminal to display the reminder message (e.g., “please check the order request”) in the form of pop-up box on the display 320 of the user terminal. In some embodiments, the first reminder signal may direct the user terminal of the passenger to generate a reminder sound by a speaker of the user terminal to notify the passenger that the order request is an incorrect order request. The passenger may customize the reminder sound by an application for inputting the order request (e.g., an car-hailing application). The customized sound may include human sounds, animal sounds, a piece of music, or a combination thereof, etc. In some embodiments, the first reminder signal may direct the user terminal of the passenger to display a recommended order request indicating a potential correct order request for replacing the order request. In some embodiments, the first reminder signal may direct the user terminal of the passenger to display an inquiry option that prompts the passenger to confirm or deny the identification that the order request is an incorrect request.

In some embodiments, after receiving (e.g., seeing or hearing) the information provided by the reminder from the user terminal, the passenger may take certain actions such as but not limited to agreeing to the recommended order request or denying the recommended order request. In certain embodiments, in response to the inquiry option the passenger may confirm or deny that the order request is an incorrect request. Further, when the passenger denies that the order request is an incorrect request, the user terminal may transmit the denial to the processor, which may unblock the interrupted order allocation process and allocate a driver based on the order request.

In some embodiments, the order allocation process is only partly interrupted. For example, the processor may tentatively assign a driver or a number of drivers to the order request but do not affirmatively start the trip, and generate a second reminder signal and transmit the second reminder signal to a user terminal of the driver (e.g., the provider terminal 140) when the order request is identified as the incorrect order request. When allocating the order request to a driver, the processor may transmit a second reminder signal to the user terminal of the driver via the network 120. The second reminder signal may direct the user terminal of the driver to display a reminder, indicating the order request is likely an incorrect order request, to the driver. After receiving the reminder, in some embodiments, the driver may attempt to confirm the information about the order request to the passenger by a phone call, a message through the processor (i.e. via the application of the car-hailing service), or a dialog box with the passenger through the processor (i.e. via the application of the car-hailing service). For example, the driver may enquire the passenger whether the current request is an incorrect order request. The reminder may be displayed in the form of a reminder message, a reminder sound, etc.

In some embodiments, after receiving a, an answer from the passenger regarding whether order request is correct or incorrect, the driver, through his/her user terminal, may take actions about the order request For example, if the passenger denies that the order request is an incorrect order request and transmit the denial to the driver, e.g. through the car hailing application, the driver, upon receiving the message, can request the server 110 to officially allocate the order and start the trip. In some embodiments, such a process is automatic and the server can unblock the interrupted allocation without the request from the driver.

It should be noted that the above description of the process 500 is merely provided for the purposes of illustration, and not intended to limit the scope of the present disclosure. For persons having ordinary skills in the art, multiple variations and modifications may be made under the teachings of the present disclosure. For example, operation 504 and operation 506 may be integrated into a single operation. However, those variations and modifications do not depart from the scope of the present disclosure.

FIG. 6 is a flowchart illustrating an exemplary process for training an identification model according to some embodiments of the present disclosure. In some embodiments, the process 600 may be implemented in the IORI system 100. For example, the process 600 may be stored in the storage device 150 and/or the storage (e.g., the ROM 230, the RAM 240, or the storage 390) as the form of instructions, and invoked and/or executed by the server 110 (e.g., the processing device 112 of the server 110, or the processor 220 of the computing device 200).

In 600, the processor (e.g., the acquisition module 402 of the processing device 112) may label a plurality of historical orders based on whether the historical order is an incorrect order. In some embodiments, the processor may obtain the plurality of historical orders from a storage (e.g., the storage device 150). The plurality of historical orders may include correct orders and incorrect orders. In some embodiments, the incorrect order may be identified based on some criteria. For example, the criteria may include service feedback information, an immediately cancelled order, and so on. The service feedback information may include information indicating a wrong order from a passenger. It should be understood that the criteria about an incorrect order may be various, and such variations may be within the protect scope of the present disclosure.

In some embodiments, the processor may classify the obtained plurality of historical orders into two groups including a first group and a second group. The first group may include the correct historical orders. The second group may include the incorrect historical orders. In some embodiments, the processor may label a correct historical order and/or an incorrect historical order with a binary value respectively. For example, a correct historical order may be labelled by “1”, an incorrect historical order may be labelled by “0”. For those skilled in the art, at least one portion of the labelled historical orders may be used to train an identification model.

In 604, the processor (e.g., the acquisition module 402 of the processing device 112) may extract at least one feature of each of the plurality of labelled historical orders. Exemplary feature may include basic features, real-time features or passenger features, or the like, or any combination thereof. The basic feature may include travel mode (e.g., an Express car mode, an ExpressPool car mode, a luxury car mode, a business van mode, etc.), a pick-up location, a drop-off location, a price, a tip, or the like, or any combination thereof. The real-time feature may include a weather condition, a time, a traffic condition, the number of order requests in a region or neighborhood, the number of candidate drivers in a region or neighborhood, or the like, or any combination thereof. The passenger feature may include a passenger age, a passenger gender, a passenger job, an order cancellation rate, or the like, or any combination thereof.

In some embodiments, the processor may extract the at least one feature of each of the plurality of labelled historical orders based on feature engineering. The feature engineering may include feature extraction, feature selection, feature construction, feature learning, or the like, or any combination thereof. For example, the processor may obtain the features from a plurality of historical orders based on a commercial automated feature engineering (e.g., Featuretools). The extracted features may further be used as input of the identification model for further training the identification model.

In some embodiments, the identification model may include an Extreme Gradient Boosting (Xgboost) model, a decision tree model, a Gradient Boosted Decision Tree (GBDT) model, a linear regression model, a neural network model, or the like, or any combination thereof. In preferred embodiments, the identification model may be the Xgboost model. The Xgboost model may include a set of model trees. The identification model may output a probability of incorrection of an order request.

In 606, the processor (e.g., the training module 404 of the processing device 112) may apply the plurality of historical orders and the plurality of extracted features into the identification model. The processor may further train the identification model based on the plurality of historical orders and the plurality of extracted features.

During training, the processor may generate a set of model trees (e.g., a model tree 800 as illustrated in FIG. 8) based on the plurality of extracted features and the plurality of historical orders. For each of the set of model trees, the processor may map the plurality of features into corresponding spilt points of the model tree. Each spilt points may correspond to a feature. The processor may spilt the model tree into one or more leaves (e.g., a leaf 802 as illustrated in FIG. 8) based on the spilt points and a preset Logistic loss function. Each model tree may include one or more leaves. In some embodiments, the processor may determine a structure of the model tree based on the number of leaves. Each model tree may be a boosting tree for the Xgboost model. The identification model may include a plurality of boosting trees. In some embodiments, the model tree may be constructed according to a Gradient Boosting method.

The identification model may be determined based on the Xgboost model. The Xgboost model may be an integrated machine learning model with high precision. The Xgboost model may process sparse features, and train automatically in parallel by multi-threading of CPU/processor of the computing device 200. One or more boosting trees may be trained based on the Xgboost model. In some embodiments, the trained boosting trees may be designated as the identification model. The trained identification model may further estimate a probability of incorrection of an order request.

Each model tree may include a categorical regression tree (CART). In some embodiments, the objective function of the identification model may include a loss function (e.g., L(θ)) and a regularization factor (e.g., Ω(θ)). The loss function may measure how well the model fits with the training data (i.e., the plurality of extracted features). The regularization factor may measure the complexity of the model tree. In some embodiments, the loss function may include the Logistic loss function, which is used to reduce or prevent overfitting.

In 608, the processor (e.g., the training module 404 of the processing device 112) may adjust parameters of the identification model to minimize the objective function of the identification model.

In some embodiments, the objective function may be expressed as shown in Equation (1):

Obj(θ)=L(θ)+Ω(θ) (1)

wherein, Obj(θ) denotes an objective function, L(θ) denotes a loss function, and Ω(θ) denotes a regularization factor. In some embodiments, the processor may adjust the parameters of the identification model automatically based on the smallest value of the objective function. The parameters may include a structure of each model tree, a weight of each leaf of the tree, or the like, or any combination thereof. The structure of a tree may depend on the number of leaves in the tree. The weight of each leaf of the tree may refer to a prediction score of each leaf. In some embodiments, the prediction score may be determined based on Equation (2).

For the Xgboost model, the optimal weight of each leaf may be expressed as shown in Equation (2):

$${ω}_{j}^{*} = \frac{{Σ}_{i ∈ {I}_{j}} {g}_{i}}{{Σ}_{i ∈ {I}_{j}} {h}_{i} + λ} , \qquad ( 2 )$$

wherein ω*ⱼ denotes the optimal weight of each leaf, j denotes an index of a leaf, i denotes an index of a training sample (i.e., an historical order for training), Iⱼ denotes an instance set including one or more training samples in a leaf, gᵢ denotes a first partial derivative of the loss function L(θ), hᵢ denotes a second partial derivative of the loss function L(θ), and λ denotes a first constant value including in the regularization factor Ω(θ).

In some embodiments, let

Gⱼ=Σ_{i∈I}_{ⱼ}gᵢ (3),

Hⱼ=Σ_{i∈I}_{ⱼ}hᵢ (4),

The objective function may be transformed to Equation (5) based on Equation (3) and Equation (4), as follows:

$$Obj = - \frac{1}{2} {\sum }_{j = 1}^{T} \frac{{G}_{j}^{2}}{{H}_{j} + λ} + γ T , \qquad ( 5 )$$

wherein γ denotes a second constant value including in the regularization factor Ω(θ). T denotes the number of leaves in a tree.

In some embodiments, the processor may determine parameters of the identification model (e.g., the structure of a model tree, the weight of each leaf) by minimize the objective function as illustrated in Equation (5).

Characteristics of the Xgboost model may include: (1) the objective function may include a regularization factor indicating the complexity of the tree model; (2) a second-order Taylor expansion may be introduced into the transformation of the objective function; (3) an approximation algorithm may be achieved based on the spilt points; (4) a sparsity of the features used; (5) the training data may be stored in the form of a block, which is beneficial to parallel computing; and (6) an architecture-oriented optimization may be achieved, such as the optimization of memory and/or cache.

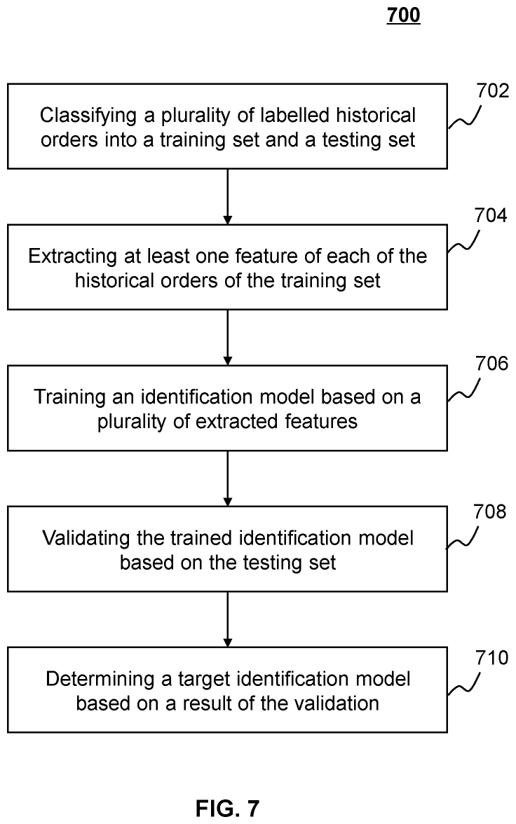

FIG. 7 is a flowchart illustrating an exemplary process for determining a target identification model according to some embodiments of the present disclosure. In some embodiments, the process 700 may be implemented in the IORI system 100. For example, the process 700 may be stored in the storage device 150 and/or the storage (e.g., the ROM 230, the RAM 240, or the storage 390) as the form of instructions, and invoked and/or executed by the server 110 (e.g., the processing device 112 of the server 110, or the processor 220 of the computing 200).

In 702, the processor (e.g., the acquisition module 402 of the processing device 112) may classify a plurality of labelled historical orders into a training set and a testing set. The testing set may include a first portion of labelled historical orders (herein also referred to as training samples). The testing set may include a second portion of labelled historical orders (herein also referred to as testing samples). The training set may be used to train the identification module, and the testing set may be used to verify an accuracy of the trained identification model.

In some embodiments, the processor may classify the plurality of labelled historical orders into the training set and the testing set based on a preset ratio between the number of the training samples and the number of the testing samples. For example, the preset ration may be 7:3. The processor may classify 70% of total labelled historical orders into the training set, and 30% of total labelled historical orders into the testing set.

In 704, the processor (e.g., the acquisition module 402 of the processing device 112) may extract at least one feature of each of the historical orders of the training set. The extracted features may be designated as the training data, and used as input to the identification model. Exemplary feature may include basic features, real-time features or passenger features, or the like, or any combination thereof. The basic feature may include travel mode (e.g., an Express car mode, an ExpressPool mode, a luxury car mode, a business van mode, etc.), a pick-up location, a drop-off location, a price, a tip, or the like, or any combination thereof. The real-time feature may include a weather condition, a time, a traffic condition, the number of order requests in a region or neighborhood, the number of candidate drivers in a region or neighborhood, or the like, or any combination thereof. The passenger feature may include a passenger age, a passenger gender, a passenger job, an order cancellation rate, or the like, or any combination thereof.

In some embodiments, the processor may extract the at least one feature of each of the historical orders of the training set based on feature engineering. The feature engineering may include feature extraction, feature selection, feature construction, feature learning, or the like, or any combination thereof. For example, the processor may obtain the features from a plurality of training samples based on a commercial automated feature engineering (e.g., Featuretools). The extracted features may further be used as input of the identification model for further training the identification model. The trained identification model may output a probability of incorrection of an order request.

In 706, the processor (e.g., the training module 404 of the processing device 112) may train the identification model based on a plurality of extracted features.

In some embodiments, the identification model may include an Xgboost model. For those skilled in the art, the Xgboost model may include one or more model trees. Each of the one or more model trees may include a plurality of leaves. A structure of each tree may be trained based on the Xgboost model by inputting the plurality of extracted features. The structure of each tree may depend on the numbers of the plurality of leaves.

During training, the processor may adjust one or more parameters of the identification model by minimize an objective function of the model. The objective function may include a loss function and/or a regularization factor. For example, the objective function may be expressed as Equation (1). The loss function may measure how well the model fits with the training data, and the regularization factor may measure the complexity of the model/tree. In some embodiments, if the objective function is minimized, the training process may be completed. In some embodiments, if a value of the objective function is equal to or less than a predetermined training threshold, the training process may be completed.

In 708, the processor (e.g., the training module 404 of the processing device 112) may validate the trained identification model based on the testing set.

In some embodiments, the processor may input the plurality of testing samples to the trained identification model, and the trained identification model may output corresponding probability of incorrection of each of the plurality of testing samples. The processor may further identify whether a testing sample is a correct order or an incorrect order based on the corresponding probability of incorrection. If the probability of incorrection of an order is equal to or greater than a predetermined threshold (e.g., 0.6, 0.65, 0.7, 0.75, 0.85, 0.90, or 0.95), the processor may identify the order as the incorrect order. The processor may determine an accuracy of the identification model based on a ratio between the number of identified incorrect orders and the number of actual incorrect orders including in the testing samples. For example, assuming that the testing set includes 100 labelled incorrect historical orders, the trained identification model identifies 85 incorrect historical orders of the 100 labelled incorrect historical orders, that is, the accuracy of the trained identification model is 0.85 (i.e., 85/100).

In 710, the processor (e.g., the training module 404 of the processing device 112) may determine a target identification model based on a result of the validation. In some embodiments, the result of the validation may include the accuracy of the identification model. In some embodiments, if the accuracy of identification model is equal to or greater than a predetermined accuracy threshold (e.g., 0.6, 0.65, 0.7, 0.75, 0.85, 0.90, or 0.95), the processor may designate the identification model as the target identification model. In some embodiments, the processor may utilize the target identification model to identify whether a real-time order request from a user is an incorrect order request.

It should be noted that the above description of the process 700 for determining a target identification model is merely provided for the purposes of illustration, and not intended to limit the scope of the present disclosure. For persons having ordinary skills in the art, multiple variations and modifications may be made under the teachings of the present disclosure. For example, operation 708 and operation 710 may be integrated into a single operation. As another example, if the result of validation is less than the predetermined accuracy threshold, the identification model may be further train until the result of validation satisfies the predetermined accuracy threshold. However, those variations and modifications do not depart from the scope of the present disclosure.

FIG. 8 is a schematic diagram illustrating an exemplary structure of a model tree according to some embodiments of the present disclosure. In some embodiments, as shown in FIG. 8, for one model tree, a spilt point 802 may be spilt into a plurality of leaves (e.g., a leaf 804 and a leaf 806) based on whether a historical order is an incorrect order. The leaf may correspond to a portion of the plurality of historical orders. For example, the leaf 804 corresponds to a plurality of incorrect historical orders, and the leaf 806 corresponds to a plurality of correct historical orders (e.g., historical order 2 and historical order 5). Each leaf may be further spilt into a plurality of secondary leaves based on a feature. For example, the leaf 804 may be spilt to a secondary leaf 808 and a secondary leaf 810 based on the basic feature. If a portion of the historical orders corresponding to the leaf 804 includes the basic feature, the processor may spilt the portion of the historical orders into the leaf 808. Otherwise, the processor may spilt a portion of the historical orders into the leaf 810. Similarly, the processor may further spilt the secondary leaf 808 or the secondary leaf 810 into a plurality of secondary leaves based on a feature. The processor may generate the model tree including the plurality of leaves. Note that the processor may generate one or more model trees similar to the model tree 800 based on the Xgboost model. The one or more model trees may be used to construct the identification model.

In some embodiments, the processor may determine a plurality of spilt points based on information gains of the plurality of features. For example, before the splitting, the processor may determine information gain of each feature respectively, the feature corresponding to a maximum information gain may be designated as a spilt point. The information gain may relate to information entropy associated with the plurality of features of the historical orders. In some embodiments, the processor may determine the plurality of spilt points based on Gini index of the plurality of features. For example, before the splitting, the processor may determine Gini index of each feature respectively, the feature corresponding to a minimum Gini index may designate as a spilt point. For those skilled in the art, the information gain or the Gini index may be known, and thus not be described in detail.

A non-transitory computer readable medium (e.g., the storage device 150 or the memory 220) may be provided for identifying whether an order request is an incorrect order request. The non-transitory computer readable medium may include at least one set of instructions for identifying whether an order request is an incorrect order request. When at least one processor (e.g., the processing device 112 or the processor 220) invoke the at least one set of instructions, the processor may obtain the order request from a user. The processor may determine a probability of incorrection of the order request based on a target identification model. The target identification model may be determined by training an identification model (e.g., the Xgboost model) with a plurality of historical orders. The processor may identify whether the order request is an incorrect order request based on the determined probability of incorrection.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer-readable media having computer readable program code embodied thereon. The one or more computer-readable media may include ROM, RAM, magnetic disk, optical disk, or the like, or any combination thereof.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system for identifying an incorrect order request in an online to offline service, comprising:
a non-transitory computer-readable storage medium storing executable instructions for identifying the incorrect order request; and
at least one processor in communication with the non-transitory computer-readable storage medium, when executing the executable instructions, the at least one processor is directed to cause the system to:
receive an order request from a user terminal of a requestor, wherein the order request includes values of a plurality of features;
determine a probability of incorrection for the order request by analyzing the values of the plurality of features from the order request with a target identification model, wherein the target identification model is obtained by training an identification model with a plurality of historical orders, each including a correct or incorrect order request and being associated with the plurality of features;
identify the order request as an incorrect order request or a correct order request based on the probability of incorrection of the order request; and
communicate with the requestor through the user terminal in response to an identification that the order request is an incorrect order request.

2. The system of claim 1, wherein the at least one processor is further configured to cause the system to:
in response to the identification that the order request is an incorrect order request, interrupt an order allocation of the order request.

3. The system of claim 2, wherein to interrupt an order allocation of the order request, the at least one processor is further configured to cause the system to:
delay the order allocation of the order request for a predetermined time period.

4. The system of claim 2, wherein to communicate with the requestor through the user terminal in response to the identification that the order request is an incorrect order request, the at least one processor is configured to cause the system to:
transmit a first reminder signal to the user terminal, wherein the first reminder signal directs the user terminal of the requestor to display a reminder message that the order request is an incorrect order.

5. The system of claim 4, wherein the first reminder signal further directs the user terminal of the requestor to generate a reminder sound by a speaker of the user terminal to notify the requestor that the order request is an incorrect order.

6. The system of claim 4, wherein the first reminder signal further directs the user terminal of the requestor to display a recommended order request to replace the order request.

7. The system of claim 4, wherein the first reminder signal further directs the user terminal of the requestor to display inquiry, which prompts the requestor to confirm or deny the identification that the order request is an incorrect request.

8. The system of claim 2, wherein to interrupt an order allocation of the order request, the at least one processor is further configured to cause the system to:
transmit a second reminder signal to a user terminal of a provider, wherein the order request is allocated to the provider, and wherein the second reminder signal directs the user terminal of the provider to display a reminder to the provider that the order request is likely an incorrect order request.

9. The system of claim 1, wherein the target identification model is obtained by:
for each of the plurality of historical orders:
label the historical order based on whether the historical order is an incorrect order;
extract at least one feature of the historical order;
apply the plurality of labelled historical orders and the plurality of at least one type of features into the identification model;
adjust parameters of the identification model to minimize an objective function including a loss function of the identification model.

10. The system of claim 1, wherein the target identification model includes an Extreme Gradient Boosting (Xgboost) model.

11. A method for identifying an incorrect order request in an online to offline service, comprising:
receiving an order request from a user terminal of a requestor, wherein the order request includes values of a plurality of features;
determining a probability of incorrection for the order request by analyzing the values of the plurality of features from the order request with a target identification model, wherein the target identification model is obtained by training an identification model with a plurality of historical orders, each including a correct or incorrect order request and being associated with the plurality of features;
identifying the order request as an incorrect order request or a correct order request based on the probability of incorrection of the order request; and
communicating with the requestor through the user terminal in response to an identification that the order request is an incorrect order request.

12. The method of claim 11, further comprising:
in response to the identification that the order request is an incorrect order request, interrupting an order allocation of the order request.

13. The method of claim 12, wherein the interrupting an order allocation of the order request includes:
delaying the order allocation of the order request for a predetermined time period.

14. The method of claim 12, wherein the communicating with the requestor through the user terminal in response to the identification that the order request is an incorrect order request includes:
transmitting a first reminder signal to the user terminal, wherein the first reminder signal directs the user terminal of the requestor to display a reminder message that the order request is an incorrect order.

15. The method of claim 14, wherein the first reminder signal further directs the user terminal of the requestor to generate a reminder sound by a speaker of the user terminal to notify the requestor that the order request is an incorrect order.

16. The method of claim 14, wherein the first reminder signal further directs the user terminal of the requestor to display a recommended order request to replace the order request.

17. The method of claim 14, wherein the first reminder signal further directs the user terminal of the requestor to display inquiry, which prompts the requestor to confirm or deny the identification that the order request is an incorrect request.

18. The method of claim 12, wherein the interrupting an order allocation of the order request includes:
transmitting a second reminder signal to a user terminal of a provider, wherein the order request is allocated to the provider, and wherein the second reminder signal directs the user terminal of the provider to display a reminder to the provider that the order request is likely an incorrect order request.

19. The method of claim 11, wherein the target identification model is obtained by:
for each of the plurality of historical orders:
label the historical order based on whether the historical order is an incorrect order;
extract at least one feature of the historical order;
apply the plurality of labelled historical orders and the plurality of at least one type of features into the identification model;
adjust parameters of the identification model to minimize an objective function including a loss function of the identification model.

20. (canceled)

21. A non-transitory computer readable medium, comprising at least one set of instructions for identifying an incorrect order request in an online to offline service, wherein when executed by at least one processor of a computing device, the at least one set of instructions causes the computing device to perform a method, the method comprising:
receiving an order request from a user terminal of a requestor, wherein the order request includes values of a plurality of features;
determining a probability of incorrection for the order request by analyzing the values of the plurality of features from the order request with a target identification model, wherein the target identification model is obtained by training an identification model with a plurality of historical orders, each including a correct or incorrect order request and being associated with the plurality of features;
identifying the order request as an incorrect order request or a correct order request based on the probability of incorrection of the order request; and
communicating with the requestor through the user terminal in response to an identification that the order request is an incorrect order request.
